(19) United States
(12) Patent Application Publication
(10) Pub. No.: US 2026/0346707 A1
(43) Pub. Date: Nov. 5, 2026

(54) BRAKING DEVICE, PTO TRANSMISSION UNIT AND WORK MACHINE

(71) Applicant: DEERE & COMPANY, MOLINE, IL (US)

(72) Inventors: TOBIAS STEINER, Hainfeld (DE); PRADIP SHINDE, PUNE (IN)

(21) Appl. No.: 19/463,835

(22) Filed: Jan. 29, 2026

(30) Foreign Application Priority Data
Apr. 30, 2025 (IN) 202521041519

(51) Int. Cl. B60K 17/28; B62D 49/06; F16D 55/02

(52) U.S. Cl. CPC B60K 17/28; B62D 49/06; F16D 55/02

(57) ABSTRACT

A braking device for a PTO transmission unit includes a bearing plate having one or more recesses, a ball being arranged in each recess, and a cone having one or more cutouts in the circumferential direction on a side facing the bearing plate, wherein the balls are arranged in the cutouts.

### CROSS-REFERENCE TO RELATED APPLICATIONS

This application claims priority to India Patent Application No. 202521041519, filed Apr. 30, 2025, which is hereby incorporated by reference.

### FIELD OF THE DISCLOSURE

The disclosure relates to a braking device, a PTO transmission unit, and a work machine.

### BACKGROUND

Conventionally, PTO transmission units are provided at the front and/or rear end of work machines, for example agricultural utility vehicles. The PTO transmission units provide power and/or a rotational speed and/or a torque to assemblies or implements which are attached to the work machine and are used in field work. Implements may require different drive torques and drive rotational speeds. For this reason, PTO transmissions which provide different rotational speeds are known. The known PTO transmissions can enable the operating modes of the PTO to be switched over when not under load.

### SUMMARY

According to an aspect of the present disclosure, a braking device for a PTO transmission unit includes a bearing plate having one or more recesses, a ball arranged in each recess, and a cone having one or more cutouts in the circumferential direction on a side facing the bearing plate, the balls being arranged in the cutouts.

According to an aspect of the present disclosure, the cone and the bearing plate are arranged coaxially to each other.

According to an aspect of the present disclosure, the cone is rotatable in a first angular range with respect to the bearing plate.

According to an aspect of the present disclosure, each cutout extends in the circumferential direction in a second angular range.

According to an aspect of the present disclosure, each ball is arranged in the associated cutout and is movable in the cutout along the circumferential direction.

According to an aspect of the present disclosure, a depth of each cutout decreases outside the first angular range but within the second angular range, and a width of each cutout decreases outside the first angular range but within the second angular range.

According to an aspect of the present disclosure, the cone and the bearing plate are annular.

According to an aspect of the present disclosure, a PTO transmission unit for a work machine includes a braking device having a bearing plate having one or more recesses, a ball arranged in each recess, and a cone having one or more cutouts in the circumferential direction on a side facing the bearing plate, the balls being arranged in the cutouts.

According to an aspect of the present disclosure, the PTO transmission unit further includes an output shaft and a transmission housing, the bearing plate connected to the transmission housing, and the cone rotatably arranged in the transmission housing and mounted on the bearing plate, and a hub, a piston, a spring element, and a clutch pack, the hub and the piston are connected to the output shaft, the spring element arranged between the piston and the hub, the piston configured to exert a force on the clutch pack and engage the clutch pack when the piston is in a first position, and the braking device is configured to brake a movement or rotation of the piston when the piston is in a second position.

According to an aspect of the present disclosure, the PTO transmission unit further includes a counter plate, and a chamber formed between the counter plate and the piston such that the chamber can be selectively pressurized.

According to an aspect of the present disclosure, the spring element preloads the piston, the spring element is arranged on the hub, and the piston is movable with the spring element in the direction of the cone such that the piston and the cone are connected with a force fit.

According to an aspect of the present disclosure, the bearing plate is designed as part of the transmission housing.

According to an aspect of the present disclosure, the bearing plate and the cone are arranged coaxially to the output shaft.

According to an aspect of the present disclosure, the clutch pack is in the form of a multi-disc clutch arrangement.

According to an aspect of the present disclosure, a work machine can include the PTO transmission unit having the braking device according to any of the embodiments disclosed herein.

The above and other features will become apparent from the following detailed description and accompanying drawings.

### BRIEF DESCRIPTION OF THE DRAWINGS

The disclosure and other advantages and advantageous developments and refinements of the disclosure, both in terms of hardware and in terms of method, will be explained in greater detail below on the basis of example embodiments and with reference to the drawing. Components of equivalent or comparable function are identified here by the same reference signs. In the drawings:

FIG. 1 shows a schematic illustration of a first example embodiment of a work machine according to the disclosure;

FIG. 2 shows a schematic illustration of a first example embodiment of the braking device according to the disclosure;

FIG. 3 shows another schematic illustration of the first example embodiment of the braking device according to the disclosure;

FIG. 4 shows a schematic illustration of a second example embodiment of the braking device according to the disclosure;

FIG. 5 shows another schematic illustration of a second example embodiment of the braking device according to the disclosure;

FIG. 6 shows a schematic illustration of a first example embodiment of the PTO transmission unit according to the disclosure;

FIG. 7 shows another schematic illustration of the first example embodiment of the PTO transmission unit according to the disclosure;

FIG. 8 shows a schematic illustration of a second example embodiment of the PTO transmission unit according to the disclosure; and

FIG. 9 shows a schematic illustration of a cutout and a ball.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

With regard to the various agricultural implements, the nominal rotational speeds of the PTO shafts are nowadays standardized. Nominal rotational speeds of 540 revolutions per minute, 750 revolutions per minute, 1000 revolutions per minute and 1400 revolutions per minute have become established (standard transmission stage). These nominal rotational speeds, also known as gear stages or transmission stages, are present at the output shaft or PTO shaft within the range of the nominal engine rotational speed (maximum power). DE 10 2017 212 639 A1 discloses a PTO transmission unit. A disadvantage here is that the known PTO transmission units have a structurally too complex design, which has a short service life and/or a high degree of wear, for braking the PTO transmission units.

Proceeding from this, it is an object of the present disclosure to propose a braking device and a PTO transmission unit and a work machine which are improved in comparison. For example, it can be an object of the present disclosure to propose a braking device and a PTO transmission unit and a work machine which are more simple structurally and/or have a longer service life and/or have less need for maintenance.

This object is achieved by a braking device having the features of one or more embodiments disclosed herein, a PTO transmission unit having the features of one or more embodiments disclosed herein, and/or a work machine having the features of one or more embodiments disclosed herein. One or more embodiments herein can relate to particularly advantageous embodiments of the disclosure.

“Connected” can be understood below as mechanically connected and/or mechanically operatively connected and/or connected for conjoint rotation. For example, “connected” can be understood, additionally or alternatively, as drivably connected, that is, torque-transmittingly and/or rotational speed-transmittingly connected, and/or coupled, that is, for example mechanically coupled and/or rigidly coupled, and/or coupled for conjoint rotation. “Connectable” can be understood as mechanically connectable and/or mechanically operatively connectable and/or connectable for conjoint rotation. For example, “connectable” can be understood, additionally or alternatively, as drivably connectable, that is, torque-transmittingly and/or rotational speed-transmittingly connectable, and/or couplable, that is, mechanically couplable and/or rigidly couplable, and/or connectable for conjoint rotation. “Connected” can therefore for example be understood as a connection of two components which makes it possible to transmit energy and/or force and/or a torque and/or a rotational speed from one component to the other, for example mechanically. Further components or parts enabling such a transmission of energy and/or force and/or torque and/or transmission of a rotational speed between the two components can be provided between the two components.

According to the disclosure, a braking device for a PTO transmission unit is proposed. The braking device comprises a bearing plate and a cone. The bearing plate has one or more recesses, for example two or three or more recesses. A ball is arranged and/or mounted, for example at least partially, for example rotatably arranged and/or rotatably mounted, on and/or in each recess. The cone has, for example on a side facing the bearing plate, one or more cutouts, for example two or three or more cutouts, in the circumferential direction, for example along and/or in the direction of the circumferential direction. The balls are arranged and/or mounted, for example rotatably arranged and/or movably arranged and/or rotatably mounted and/or movably mounted, on and/or in the cutout or the cutouts. In other words, a ball can be in each case arranged and/or mounted, for example rotatably arranged and/or movably arranged and/or rotatably mounted and/or movably mounted, on and/or in each cutout. In other words, the cone can be arranged and/or mounted rotatably on the bearing plate with or by the arrangement and/or mounting of the balls on and/or in the cutouts. For example, the cone can be rotatably arranged and/or mounted on the bearing plate by virtue of the balls being arranged and/or mounted, for example rotatably arranged and/or movably arranged and/or rotatably mounted and/or movably mounted, on and/or in the cutouts. The cone can thus be rotatably arranged and/or mounted on the bearing plate, for example in the circumferential direction, according to some embodiments in both directions, and for example rotatably arranged and/or rotatably mounted relative to the bearing plate. The cutouts can be in the form of a groove or ball raceway. For example, each cutout can be assigned precisely one ball.

The bearing plate can be arrangeable for conjoint rotation, for example in the PTO transmission unit, and/or the bearing plate can be connectable to a transmission housing of the PTO transmission unit. The bearing plate can have two or more recesses, according to some embodiments two or three or four recesses. Each ball can be rotationally and/or rotatably arranged and/or mounted in the associated recess. Each ball can be translationally fixedly and/or immovably arranged and/or mounted in the associated recess. The recesses can be in the form, for example, of holes or bores or grooves or countersunk points. The bearing plate can have further recesses, which can be in the form, for example of bores. The bearing plate can be connectable or connected to the transmission housing via or with one or more fastening elements, for example screws or rivets or pins, through the further recesses. The fastening elements can be arranged in the further recesses. For example, the fastening elements can be inserted through the further recesses, for example bores or holes. The fastening elements can be connectable or connected to the transmission housing, and for example be secured, with screw threads.

Alternatively, the cone can have two or more recesses. A ball can be, for example at least partially, arranged and/or mounted, for example rotatably arranged and/or rotatably mounted, on and/or in each recess. The bearing plate can, for example on a side facing the cone, have two or more cutouts in the circumferential direction, for example along and/or in the direction of the circumferential direction. The balls can be arranged and/or mounted, for example rotatably arranged and/or movably arranged and/or rotatably mounted and/or movably mounted, on and/or in the cutouts. In other words, the cone can be arranged and/or mounted rotatably on the bearing plate with or by the arrangement and/or mounting of the balls on and/or in the cutouts. For example, the cone can be rotatably arranged and/or mounted on the bearing plate by virtue of the balls being arranged and/or mounted, for example rotatably arranged and/or movably arranged and/or rotatably mounted and/or movably mounted, on and/or in the cutouts. The cone can thus be rotatably arranged and/or mounted on the bearing plate, for example in the circumferential direction, according to some embodiments in both directions, and for example rotatably arranged and/or rotatably mounted relative to the bearing plate. Thus, the same effect according to the disclosure can be achieved.

Alternatively, the cone can have one or more recesses, and the bearing plate can have one or more recesses. The bearing plate can, for example on a side facing the cone, have one or more cutouts in the circumferential direction, for example along and/or in the direction of the circumferential direction, and the cone can, for example on a side facing the bearing plate, have one or more cutouts in the circumferential direction, for example along and/or in the direction of the circumferential direction. Thus, the same effect according to the disclosure can be achieved. Advantageously, flexibility, for example a slight movement or bending in the axis of rotation, can thereby be achieved in the rotation of the cone. In addition, the gradual rotation of the cone prevents and/or reduces the risk of sudden shocks.

In a refinement of the disclosure, the cone and the bearing plate are arranged coaxially to each other. In addition, the cone and the bearing plate can be oriented coaxially to each other. The cone and/or the bearing plate can be annular and/or hollow-cylindrical. The cone and/or the bearing plate can be oriented and/or arranged along and/or in the direction of an axis A, for example a common axis. The cone and/or the bearing plate can be arranged concentrically and/or coaxially to the axis A. The cone can be rotatably arranged and/or mounted about the axis A. The braking device has the advantages mentioned above.

In a refinement of the disclosure, the cone is, for example only, rotatable in a first angular range a with respect to the bearing plate. In other words, the cone can be rotatably arranged and/or mounted on and/or with respect to the bearing plate, for example only, in the first angular range a with or by the arrangement and/or mounting of the balls on and/or in the cutouts. For example, the cone can be rotatably arranged and/or mounted on and/or with respect to the bearing plate, according to some embodiments only, in the first angular range a by virtue of the balls being arranged and/or mounted, for example rotatably arranged and/or movably arranged and/or rotatably mounted and/or movably mounted, on and/or in the cutouts. The cone can thus be rotatably arranged and/or mounted on the bearing plate, for example in the circumferential direction, and for example rotatably arranged and/or rotatably mounted relative to the bearing plate. The first angular range a can be an angular interval or the value of an angle. The first angular range can be less than or equal to 170 degrees, less than or equal to 150 degrees, or less than or equal to 130 degrees. For example, the first angular range can be less than or equal to 110 degrees. The braking device has the advantages mentioned above.

In a refinement of the disclosure, each cutout extends in the circumferential direction with a and/or in a second angular range b, for example along and/or in the direction of the circumferential direction. The cutouts can be arranged along the circumference U of a circle having a radius R, for example a fixed radius. Each cutout can extend in the circumferential direction with the and/or in the second angular range b, for example along a partial circumference of the circle on which the cutouts are arranged. The cutouts can be arranged coaxially and/or concentrically to the axis A and/or an output shaft of the PTO transmission unit. The cutouts can be spaced and/or arranged with respect to the axis A and/or the output shaft with the same radius R. The cutouts can be spaced with respect to one another along the circumference of the circle with the radius R and have the second angular range.

The second angular range can be an angular interval or the value of an angle. The second angular range can be larger than the first angular range. The second angular range can be less than or equal to 180 degrees, less than or equal to 160 degrees, or less than or equal to 140 degrees. For example, the second angular range can be less than or equal to 120 or 130 degrees. The length of the cutout can be less than or equal to 50%, less than or equal to 45%, or less than or equal to 40%, of the circumference U of the circle with the radius R, on which the cutouts can be arranged. For example, the length of the cutout can be less than or equal to 30% or 35% of the circumference U of the circle with the radius R, on which the cutouts can be arranged. The braking device has the advantages mentioned above.

In a refinement of the disclosure, each ball is, according to some embodiments completely, arranged in the associated cutout and/or is movable and/or rotatable and/or rollable along and/or in the direction of the circumferential direction in the cutout. For example, each ball can be, according to some embodiments completely, arranged in the associated cutout and can be movable and/or rotatable and/or rollable along and/or in the direction of the circumferential direction in the second angular range in the cutout. The diameter of each ball can be smaller than a width of each cutout. Each ball can be accommodated in the associated cutout. This can advantageously prevent distortion.

In a refinement of the disclosure, a depth of the or each cutout decreases outside the first angular range but within the second angular range in comparison to the depth in the first angular range, and/or a width of the or each cutout decreases outside the first angular range but within the second angular range in comparison to the width in the first angular range. In the first angular range a, the depth and/or width can be greater than in the second angular range. If the ball moves and/or rotates and/or rolls in the region of decreasing depth and/or width, the distance between the bearing plate and the cone changes. Alternatively, the ball can strike against an edge and/or an end of the cutout in the region of decreasing depth and/or width. The edge and/or the end of the cutout, i.e., the region of decreasing depth and/or width, can be designed as a stop for the ball. This can advantageously achieve a slower rotational movement and/or deceleration between the bearing plate and the cone, thereby reducing wear and the need for maintenance and improving the service life of the braking device.

The disclosure furthermore relates to a PTO transmission unit for a work machine, comprising a braking device or having a braking device of the one or more embodiments disclosed herein. The PTO transmission unit can comprise an input shaft, which is connectable to a work machine, and/or an output shaft. The PTO transmission unit can transmit power between the input shaft and an output shaft.

In a refinement of the disclosure, the PTO transmission unit comprises the output shaft and a transmission housing. The bearing plate is connected to the transmission housing. The cone is rotatably arranged, and for example axially movably or displaceably arranged, in the transmission housing and, for example rotatably, arranged and/or mounted on the bearing plate. The PTO transmission unit furthermore comprises a hub and a piston and a spring element and a clutch pack. The hub and the piston are connected to the output shaft. The piston, for example with a form fit, can be connected to the output shaft. The spring element is arranged between the piston and the hub. The spring element can be, for example, a spring, for example a disc spring or a helical spring. The piston is configured to exert a force on the clutch pack and engage the clutch pack, for example to move and/or to bring same into an engaged position, when the piston is in a first position and/or is moved. The braking device, for example the cone, is configured to brake and/or stop a movement and/or rotation of the piston when the piston is in a second position and/or is moved, for example by the cone being, according to some embodiments only, rotatable in the first angular range a with respect to the bearing plate, such that a rotation and/or turning of the cone and/or the output shaft is braked and/or stopped.

The piston can be configured, when the piston is in the second position, not to exert any force on the clutch pack and to bring the clutch pack out of engagement, i.e., for example to move same into a disengaged position. In the first position of the piston, the cone and the piston cannot have a force fit, i.e., for example can be detached from each other. In the first position of the piston, since the cone and the piston do not have a force fit, the piston and/or the output shaft can be rotatable, for example freely rotatable. In the second position of the piston, the cone and the piston can be connected with a force fit. When the cone and the piston are connected to each other with a force fit, the braking device, for example the cone, can be configured to brake and/or stop a movement and/or rotation of the piston, when the piston is in a second position and/or is moved, for example by the cone being, according to some embodiments only, rotatable in the first angular range with respect to the bearing plate, such that a rotation and/or turning of the cone and/or the output shaft is braked and/or stopped. In the second position of the piston, since the cone and the piston are connected to each other with a force fit, the cone can be, for example only, rotatable in the first angular range with respect to the bearing plate, such that a rotation of the piston and/or the output shaft is braked and/or stopped. In the second position of the piston, since the cone and the piston have a force fit, the cone can be, for example only, rotatable in the first angular range a with respect to the bearing plate, such that a rotation of the piston and/or the output shaft, for example in the first angular range a, is braked and/or stopped.

The clutch pack can be arranged in the housing. The clutch pack can be formed and/or arranged radially symmetrically. The clutch pack can be designed for the optional transmission of energy and/or force and/or a torque and/or a rotational speed between the input shaft and the output shaft. In other words, either energy and/or force and/or a torque and/or a rotational speed can be transmissible from the input shaft to the output shaft by means of the clutch pack. The clutch pack can be in engagement or out of engagement. The clutch pack can be movable, for example movable to and fro, between a disengaged position, i.e., out of engagement, and the engaged position, i.e., in engagement. The clutch pack can connect the input shaft to the output shaft when the clutch pack is in engagement and/or in the engaged position, and for example transmit energy and/or force and/or a torque and/or a rotational speed between the input shaft and the output shaft. For example, the clutch pack can be configured to connect the input shaft to the output shaft when the clutch pack is in engagement and/or in the engaged position, and for example transmit energy and/or force and/or a torque and/or a rotational speed between the input shaft and the output shaft. The clutch pack cannot connect the input shaft to the output shaft, i.e. for example can release a connection of the input shaft to the output shaft, when the clutch pack is out of engagement and/or in the disengaged position, and for example cannot transmit energy and/or force and/or any torque and/or any rotational speed between the input shaft and the output shaft. For example, the clutch pack can be configured not to connect the input shaft to the output shaft, i.e. for example to release a connection of the input shaft to the output shaft, when the clutch pack is out of engagement and/or in the disengaged position, and for example cannot transmit energy and/or force and/or any torque and/or any rotational speed between the input shaft and the output shaft.

Advantageously, a structurally simple configuration of the PTO transmission unit, for example also of the braking device, can thereby be achieved. The design allows for slight movement or bending of the output shaft, which facilitates, for example, a rotational orientation of the PTO shaft on the attachment. In addition, it can be of advantage to reduce the wear and outlay on maintenance of the PTO transmission unit. Less outlay on maintenance is required because of the design and the reduced friction points. The PTO transmission unit, for example the braking device, reduces the risk of sudden shocks. The service life and/or longevity of the PTO transmission unit, for example of the braking device, is also increased.

In a refinement of the disclosure, the PTO transmission unit comprises a counter plate. A chamber is formed, for example at least partially, between the counter plate and the piston. The chamber can be selectively pressurized, for example with a fluid. For example, the PTO transmission unit, for example the chamber, can be configured to selectively pressurize the chamber, for example to move the piston into the first position. In other words, the PTO transmission unit can be configured to move the piston into the first position and the piston to exert a force on the clutch pack and bring the clutch pack into engagement, for example to move same into the engaged position when the chamber is and/or has been pressurized.

The PTO transmission unit can be configured to move the piston into the second position when the chamber is not pressurized or is free of pressure. The braking device, for example the cone, can be configured to brake and/or stop a movement and/or rotation of the piston when the piston is in a second position and/or is moved, for example by the cone being, according to some embodiments only, rotatable in the first angular range with respect to the bearing plate, such that a rotation and/or turning of the cone and/or the output shaft is braked and/or stopped. For example, the PTO transmission unit can be configured to move the piston into the first position when the chamber is pressurized, and the piston can be configured to exert a force on the clutch pack and to bring the clutch pack into engagement when the chamber is pressurized. In addition, the PTO transmission unit, for example the spring element, can be configured to move the piston into the second position when the chamber is not pressurized or is free of pressure. The braking device, for example the cone, can be configured to brake and/or stop a movement and/or rotation of the piston when the piston is in a second position and/or is moved, for example by the cone being, according to some embodiments only, rotatable in the first angular range with respect to the bearing plate, such that a rotation and/or turning of the cone and/or the output shaft is braked and/or stopped. The fluid can be a liquid or a gas. The chamber can be coupled to a liquid or gas source to fill the chamber with the fluid. The PTO transmission unit has the advantages mentioned above.

In a refinement of the disclosure, the spring element preloads the piston. The spring element can be mounted and/or arranged, for example supported, on the hub and/or the piston. The piston can be movable with the spring element in the direction of the cone, for example can be movable in the axial direction, such that the piston and the cone are connected with a force fit. The spring element can, for example permanently, exert a force on the piston such that the piston can be preloaded. The spring element can be arranged and/or mounted, for example tensioned or preloaded, between the piston and the hub. In other words, the spring element can be configured to move the piston into the second position such that the piston and the cone are connected with a force fit, for example when the chamber is not pressurized or is free of pressure. The cone can be centered at or on the piston when the piston is in the second position. In addition, the cone can be centered with respect to the bearing plate by means of the balls. The bearing plate, in turn, can be centered with respect to the axis A. The PTO transmission unit has the advantages mentioned above.

In a refinement of the disclosure, the bearing plate is designed as part of the transmission housing. The bearing plate and the transmission housing can be integrally formed. By this means, a structurally simple design can advantageously be achieved.

In a refinement of the disclosure, the bearing plate and the cone are arranged, and for example mounted, coaxially to the output shaft The cone and the bearing plate can be arranged coaxially to each other. In addition, the cone and the bearing plate can be oriented coaxially to each other. The cone and/or the bearing plate can be annular and/or hollow-cylindrical. The cone and/or the bearing plate can be oriented and/or arranged along and/or in the direction of the output shaft. The cone and/or the bearing plate can be arranged concentrically and/or coaxially to the output shaft. The cone can be rotatably arranged and/or mounted with the output shaft about the axis A. The PTO transmission unit has the advantages mentioned above.

In a refinement of the disclosure, the clutch pack is in the form of a multi-disc clutch arrangement, according to some embodiments a wet-running or dry multi-disc clutch arrangement. The clutch pack can be in the form of a multi-disc clutch arrangement, according to some embodiments a wet-running or dry multi-disc clutch arrangement. The clutch pack, for example the multi-disc clutch arrangement, can comprise one or more clutch discs or friction discs. The clutch disc or friction disc, for example each clutch disc or friction disc, can comprise one or more friction linings. The clutch disc or friction disc, for example each clutch disc or friction disc, can be connected to the input shaft or output shaft, according to some embodiments to an input or output disc carrier, according to some embodiments connected for conjoint rotation and/or with a form fit. The clutch pack, for example the multi-disc clutch arrangement, can comprise one or more separating discs or plates. The clutch pack, for example the multi-disc clutch arrangement, can comprise at least two separating discs or plates.

In each case at least one separating disc or plate can be arranged on the one side and on the other side of the clutch disc or friction disc. The separating disc or plate, for example each separating disc or plate, can be connected to the input shaft or output shaft, according to some embodiments to the input or output disc carrier, according to some embodiments connected for conjoint rotation and/or with a form fit. Either all of the clutch discs or friction discs can be connected to the input shaft, according to some embodiments to the input disc carrier, according to some embodiments connected for conjoint rotation and/or with a form fit, and all of the separating discs or plates can be connected to the output shaft, according to some embodiments to the output disc carrier, according to some embodiments connected for conjoint rotation and/or with a form fit, or vice versa.

For example, the input shaft can comprise the input disc carrier and/or can be connected thereto. For example, the input disc carrier can be formed as part of the input shaft. For example, the output shaft can comprise the output disc carrier and/or can be connected thereto. For example, the output disc carrier can be formed as part of the output shaft. The hub can comprise the output disc carrier and/or can at least partially be formed as the latter.

The clutch pack can be movable between the disengaged position and the engaged position, for example can be movable to and fro. For example, in the first position, the piston can move the clutch pack into the engaged position. The piston can therefore be configured to move the clutch pack into the engaged position. In the engaged position, the piston can exert a force on the plates or separating discs and/or the friction linings. In the engaged position, the piston can compress or clamp the plates or separating discs and/or the friction linings, for example in such a way that energy and/or force and/or a torque and/or a rotational speed can be transmitted between the input disc carrier and an output disc carrier.

The disclosure furthermore relates to a work machine having a PTO transmission unit of the one or more embodiments disclosed herein. The work machine can be a construction machine or a towing vehicle, according to some embodiments an agricultural towing vehicle, for example a tractor. The work machine has the above-described advantages.

The work machine can comprise a drive unit. The work machine can be drivable with a rotational speed and/or force and/or a torque of a drive unit. The drive unit can be connectable or connected to the input shaft. The drive unit can be, for example, an internal combustion engine or an electric motor. The work machine can comprise the one or more ground-engaging means. The ground-engaging means can support and/or carry the work machine on the ground. The ground-engaging means can be wheels or tracks or chains. For example, the ground-engaging means can be front wheels and rear wheels.

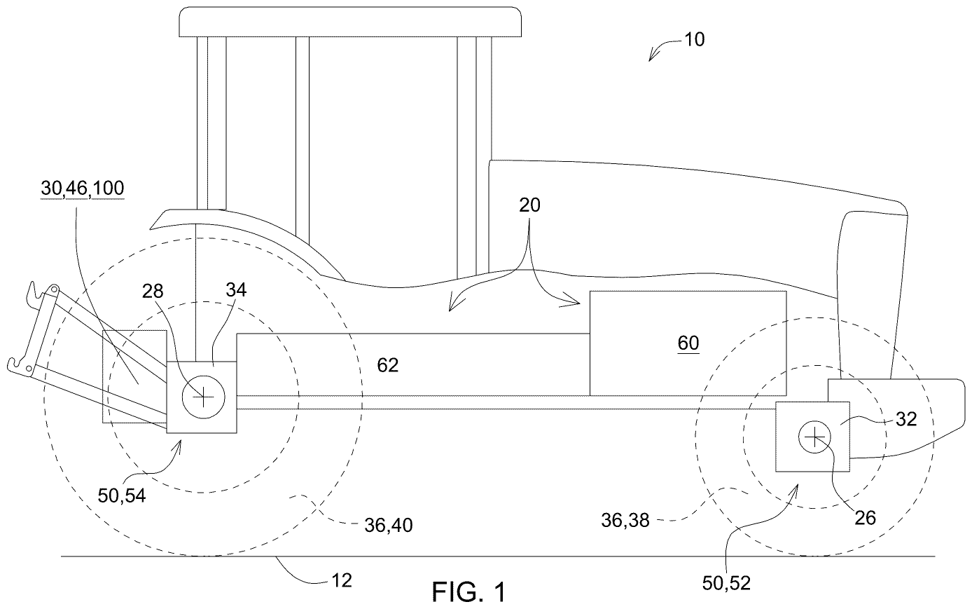

FIG. 1 shows a schematic illustration of a first example embodiment of a work machine 10 according to the disclosure, here of an agricultural towing vehicle or tractor, for example having a braking device 100 and PTO transmission unit 30 according to the disclosure. The work machine 10 comprises a drive train 20 according to the disclosure. In addition, the work machine 10 is drivable by the drive train 20.

The work machine 10, for example the drive train 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The work machine 10, for example the drive device 20, can comprise a traction drive 50, for example a front-axle drive 52 and a rear-axle drive 54. The work machine 10 can have one or more ground-engaging means 36, in this case illustrated in the form of wheels 38, 40, which engage with an underlying surface 12 in order to transmit drive forces and/or by way of which the work machine 10 is supported on the underlying surface 12. Alternatively, the ground-engaging means 36 can also be configured and arranged as tracks or chains.

The traction drive 50 can comprise the first vehicle axle 26 and/or the second vehicle axle 28 and/or a first differential 32 and/or a second differential 34 and/or the one or more ground-engaging means 36. The first vehicle axle 26 can be connected to the first differential 32. The second vehicle axle 28 can be connected to the second differential 34.

The work machine 10, for example the drive train 20, comprises a drive unit 60 and a transmission 62. With the drive train 20, for example the drive unit 60, a rotational movement and/or force and/or a torque and/or a rotational speed can be generatable and can be transmissible, for example via the transmission 62, to the first and/or second vehicle axle 26, 28. The first and/or second vehicle axle 26, 28 convert the rotational movement and/or force and/or the torque and/or the rotational speed into a rotational movement and/or force and/or torque and/or rotational speed of one or more ground-engaging means 36, and thus into propulsion of the work machine 10.

The work machine 10, for example the drive train 20, can comprise a first power output 46. The first power output can comprise the PTO transmission unit 30. The first power output 46, for example PTO transmission unit, can be provided for the purpose of driving an implement (not shown), which is attachable to the work machine 10 via an interface (e.g., three-point interface).

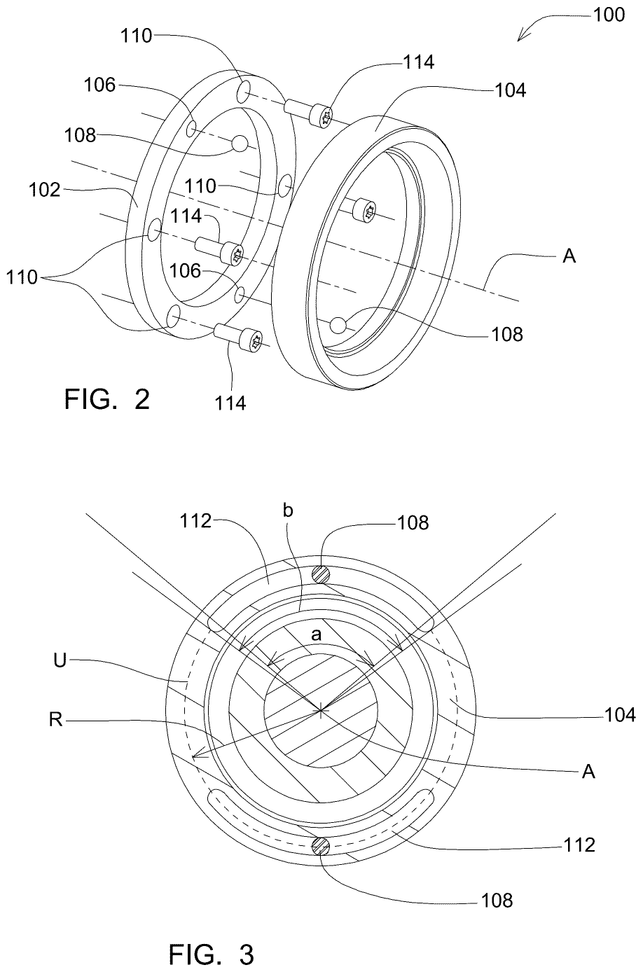

FIG. 2 shows a schematic illustration of a first example embodiment of the braking device 100 according to the disclosure. The braking device 100 shown in FIG. 2 substantially corresponds to the braking device 100 shown in FIG. 1, and therefore only details and/or points of differentiation will be discussed below. The work machine 10 illustrated in FIG. 1 can comprise the braking device 100 illustrated in FIG. 2.

The braking device 100 for a PTO transmission unit 30 comprises a bearing plate 102 and a cone 104 and one or two or more balls 108. The braking device 100 according to FIGS. 2 and 3 comprises two cutouts 112 and two balls 108. The bearing plate 102 can be arranged for conjoint rotation, for example can be connectable to a transmission housing 204. In addition, the bearing plate 102 has one or more recesses 106, in the present case precisely two recesses. A ball 108 is, for example completely, arranged and mounted, for example is turnably and/or rotatably and/or translationally immovably arranged and mounted, on and/or in each recess 106. The recesses 106 can be in the form, for example, of holes or bores or grooves. The bearing plate 102 can have further recesses 110, which can be in the form for example of bores. The bearing plate 102 can be connectable or connected to the transmission housing 204 via or with one or more fastening elements 114, for example screws in the present case.

The cone 104 has, for example on a side facing the bearing plate 102, one or more, here two, cutouts 112 (see FIG. 3) in the circumferential direction, for example along and/or in the direction of the circumferential direction. The balls 108 are movably and/or rotatably arranged or arrangeable and/or mounted or mountable on or in the cutouts 112. The cutouts 112 can be in the form of a groove or ball raceway. For example, each cutout 112 can be assigned precisely one ball 108.

The cone 104 can be rotatably arranged and mounted on the bearing plate 102. In addition, the cone 104 can be rotatable relative to the bearing plate 102. For example, the cone 104 can be movably or rotatably arranged and/or mounted, for example in the circumferential direction, on the bearing plate 102. In other words, the cone 104 can be rotatably arranged and/or mounted on the bearing plate 102 with or by the arrangement and/or mounting of the balls 108 on and/or in the cutouts 112.

The cone 104 and/or the bearing plate 102 can be annular. In addition, the cone 104 and the bearing plate 102 can be arranged and/or oriented coaxially to each other. The cone 104 and/or the bearing plate 102 can be oriented and/or arranged along and/or in the direction of an axis A, for example a common axis. The bearing plate 102 can be arranged concentrically and/or coaxially to the axis A. The cone 104 can be rotatably arranged and/or mounted about the axis A.

FIG. 3 shows another schematic illustration of the first example embodiment of the braking device 100 according to the disclosure. The braking device 100 shown in FIG. 3 substantially corresponds to the braking device 100 shown in FIGS. 1 and 2, and therefore only details and/or points of differentiation will be discussed below. The work machine 10 illustrated in FIG. 1 or the drive train 20 can comprise the braking device 100 illustrated in FIG. 3.

The cone 104 can be, for example only, rotatable in a first angular range a with respect to the bearing plate 102. In other words, the cone 104 can be rotatably arranged and/or mounted on the bearing plate 102 with or by means of the arrangement and/or mounting of the balls 108 on and/or in the cutouts 112, for example can be rotatable only in the first angular range a with respect to the bearing plate 102.

The cutouts 112 can be arranged along the circumference U of a circle having the radius R. Each cutout 112 can extend in a second angular range b in the circumferential direction. Each cutout can extend in the circumferential direction in the second angular range b, for example along a partial circumference of the circle on which the cutouts are arranged, for example along and/or in the direction of the circumferential direction. The cutouts 112 can be arranged coaxially and/or concentrically to the axis A and/or an output shaft 202. The cutouts 112 can be spaced and/or arranged with respect to the axis A and/or the output shaft 202 with the same radius R. Each ball 108 can be arranged, for example completely, in the associated cutout 112 and movable along and/or in the direction of the circumferential direction in the cutout 112. For example, each ball 108 can be arranged, for example completely, in the associated cutout 112. Each ball 108 can be movable along and/or in the direction of the circumferential direction in the second angular range b in the cutout 112.

A depth T of each cutout 112 outside the first angular range a but within the second angular range b can decrease and/or a width B of each cutout 112 outside the first angular range a but within the second angular range b can decrease. As a result, the distance between the bearing plate 102 and the cone 104 can change when the cone is rotated or strikes against the edge of the cutout.

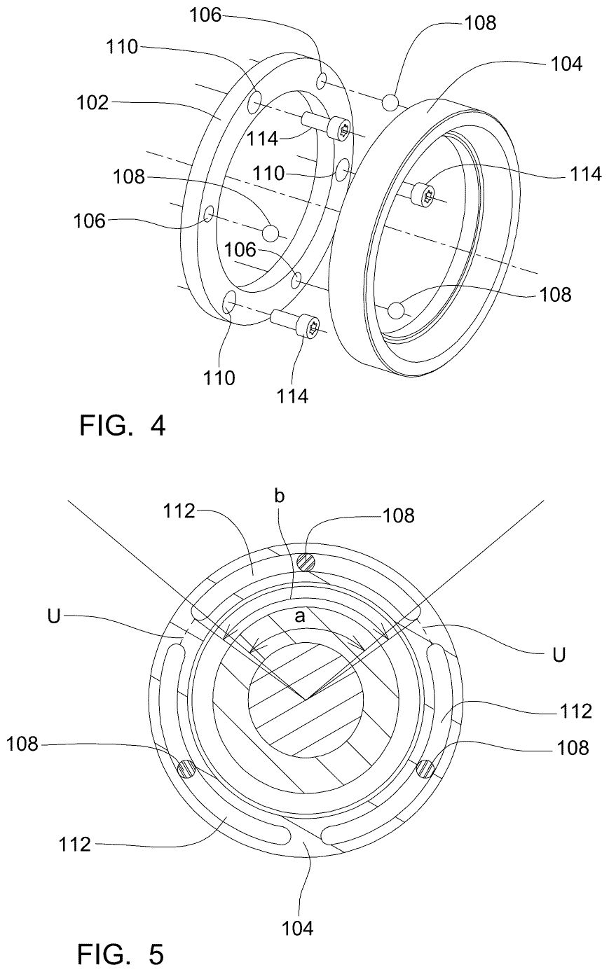

FIGS. 4 and 5 show a schematic illustration of a second example embodiment of the braking device 100 according to the disclosure. The braking device 100 shown in FIGS. 4 and 5 substantially corresponds to the braking device 100 shown in FIGS. 1 to 3, and therefore only details and/or points of differentiation will be discussed below. The work machine 10 illustrated in FIG. 1 or the drive train 20 can comprise the drive braking device 100 illustrated in FIGS. 4 and 5. The braking device 100 shown in FIGS. 4 and 5 has three recesses 106 and three cutouts 112. Unlike the braking device 100 shown in FIGS. 2 and 3, the cutouts 112 shown in FIGS. 4 and 5 have a constant depth over the entire length of the cutout 112 but a decreasing width outside the first angular range a but within the second angular range b. A movement of the balls 108 can be stopped by or with the edges or ends of the cutout 112.

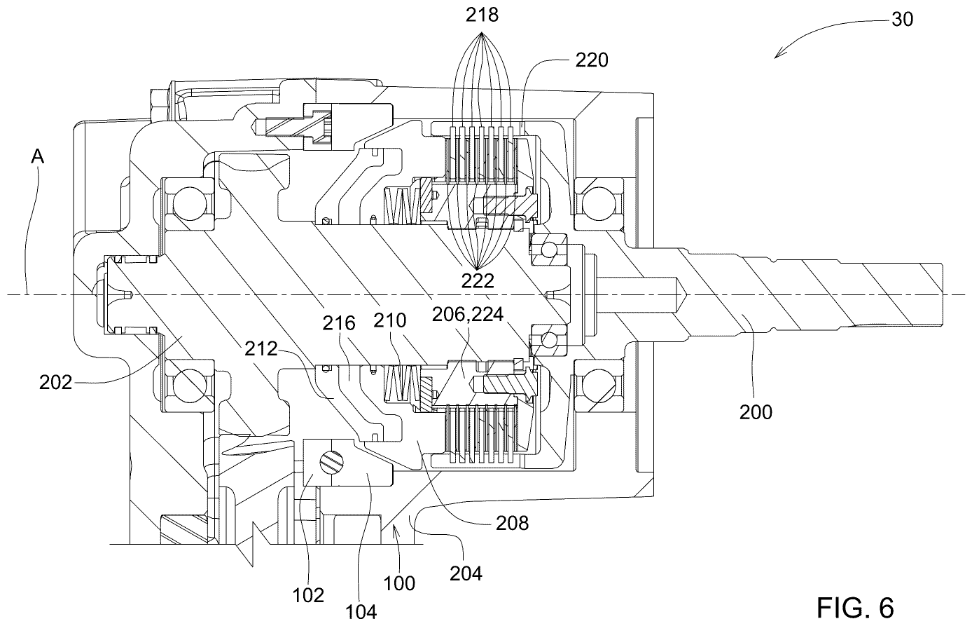

FIG. 6 shows a schematic illustration of a first example embodiment of the PTO transmission unit 30 according to the disclosure. The PTO transmission unit 30 shown in FIG. 6 substantially corresponds to the PTO transmission unit 30 shown in FIGS. 1 to 5, and therefore only details and/or points of differentiation will be discussed below. The PTO transmission unit 30 shown in FIG. 6 can comprise the braking device 100 shown in FIGS. 1 to 5, and therefore only details and/or points of differentiation will be discussed below. The work machine 10 illustrated in FIG. 1 or the drive train 20 can comprise the PTO transmission unit 30 illustrated in FIG. 6.

The PTO transmission unit 30 for the work machine 10 comprises the braking device 100. The PTO transmission unit comprises an input shaft 200 and an output shaft 202 and the transmission housing 204. With the PTO transmission unit 30, a rotational speed and/or a torque and/or a power can be transmissible or transmitted between an input shaft 200, which is for example connectable or connected to the work machine 10, and an output shaft 202.

The bearing plate 102 is connected to the transmission housing 204. The cone 104 is rotatably arranged and/or mounted on the bearing plate 102, for example about the axis A, and axially movably in the transmission housing 204. The PTO transmission unit 30 furthermore comprises a hub 206 and a piston 208 and a spring element 210 and a counter plate 212 and a clutch pack 214. The hub 206 and the piston 208 are connected to the output shaft 202, for example the piston can be connected to the output shaft 202 with a form fit. The spring element 210 is arranged between the piston 208 and the hub 206. The piston 208 is configured to exert a force on the clutch pack 214 and engage the clutch pack 214, that is, for example to move same into the engaged position when the piston 208 is in a first position. FIG. 6 shows the piston 208 in the first position. The braking device 100, for example the cone 104, is configured to brake and/or stop a rotation of the piston 208 when the piston 208 is in a second position, and, for example, the cone 104 is, according to some embodiments only, rotatable in the first angular range a with respect to the bearing plate 102, such that a rotation of the piston 208 and/or the output shaft 202 is braked and/or stopped.

The PTO transmission unit 30 can comprise a counter plate 212. A chamber 216 is formed between the counter plate 212 and the piston 208. The chamber 216 is selectively pressurized, for example with a fluid which may be gaseous or liquid. The spring element 210 preloads the piston 208. The spring element is mounted and/or supported on the hub 206. The piston 208 is movable with the spring element 210 in the direction of the cone 104, and/or for example into the second position, such that the piston 208 and the cone 104 are connected with a force fit. In other words, the spring element 210 is configured to move the piston 208 into the second position, such that the piston 208 and the cone 104 are connected with a force fit. The PTO transmission unit 30, for example the spring element 210, can thus be configured to move the piston 208 into the second position. The bearing plate 102 and the cone 104 are arranged coaxially to the output shaft 202. The cone 104 and the bearing plate 102 are arranged along and/or in the direction of the output shaft 202, and for example the axis A. The cone 104 is rotatably arranged and/or mounted about the output shaft 202, and for example the axis A.

The clutch pack 214 is in the form of a multi-disc clutch arrangement. The clutch pack 214 comprises a plurality of friction discs 218 which are provided with friction linings. The input shaft 200 comprises the input disc carrier 220, which is formed as part of the input shaft 200. The friction discs 218 are connected to the input disc carrier 220, for example connected for conjoint rotation. The clutch pack 214 also comprises a plurality of separating discs 222, which are each arranged on the one or the other side of the friction discs 218 and connected to the output disc carrier 224, for example connected for conjoint rotation. In the present case, the output shaft 202 comprises the hub 206, or the hub 206 is formed as part of the output shaft 202. In addition, the hub 206 comprises the output disc carrier 224, or the output disc carrier 224 is formed as part of the hub 206. The clutch pack can be movable between the disengaged position and the engaged position.

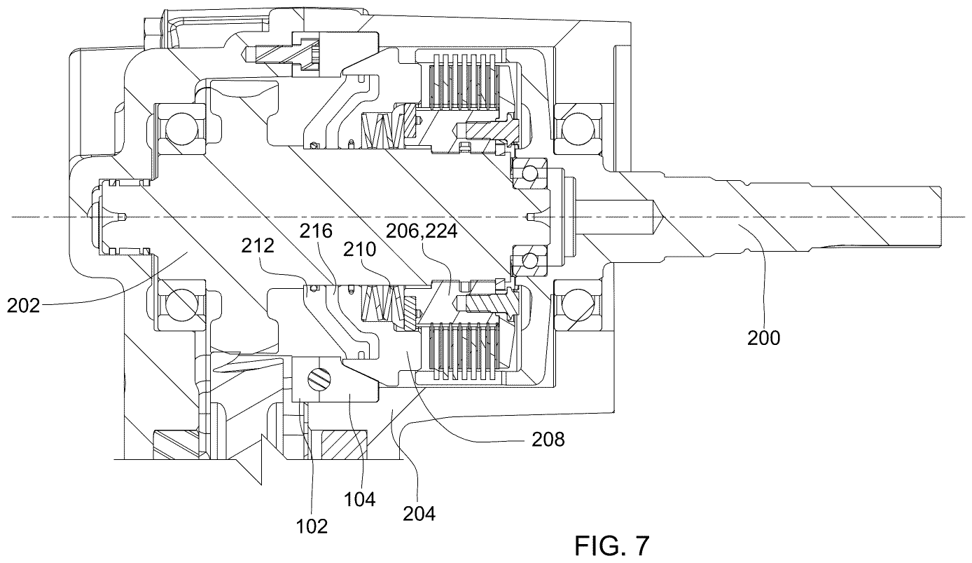

FIG. 7 shows another schematic illustration of the first example embodiment of the PTO transmission unit 30 according to the disclosure. The PTO transmission unit 30 shown in FIG. 7 substantially corresponds to the PTO transmission unit 30 shown in FIGS. 1 to 6, and therefore only details and/or points of differentiation will be discussed below. The PTO transmission unit 30 shown in FIG. 7 can comprise the braking device 100 shown in FIGS. 1 to 6, and therefore only details and/or points of differentiation will be discussed below. The work machine 10 illustrated in FIG. 1 or the drive train 20 can comprise the PTO transmission unit 30 illustrated in FIG. 7. FIG. 7 shows the piston 208 in the second position.

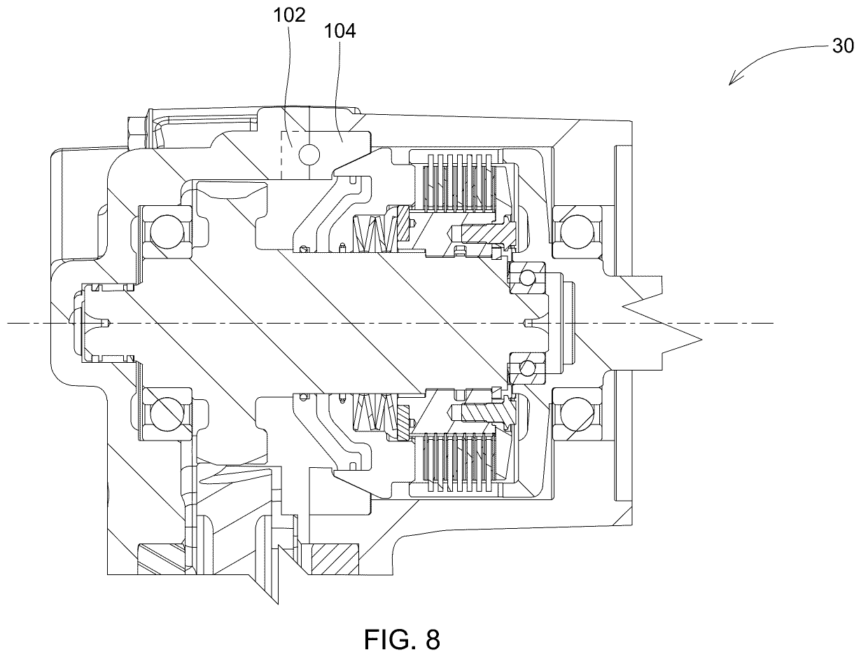

FIG. 8 shows a schematic illustration of a second example embodiment of the PTO transmission unit 30 according to the disclosure. The PTO transmission unit 30 shown in FIG. 8 substantially corresponds to the PTO transmission unit 30 shown in FIGS. 1 to 7, and therefore only details and/or points of differentiation will be discussed below. The PTO transmission unit 30 shown in FIG. 8 can comprise the braking device 100 shown in FIGS. 1 to 7, and therefore only details and/or points of differentiation will be discussed below. The work machine 10 illustrated in FIG. 1 or the drive train 20 can comprise the PTO transmission unit 30 illustrated in FIG. 8. In contrast to the PTO transmission unit 30 shown in FIGS. 6 and 7, the bearing plate 102 is formed as part of the transmission housing 204.

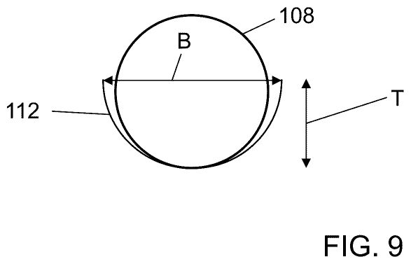

FIG. 9 shows a detailed schematic illustration of the cutout 112 and the ball 108. The illustration of the cutout 112 and the ball 108 shown in FIG. 9 substantially corresponds to the illustration of the cutout 112 and the ball 108 shown in FIGS. 1 to 8, and therefore only details and/or points of differentiation will be discussed below. FIG. 9 shows the depth T and width B of the cutout 112. The width B of the cutout 112 can be greater than the diameter of the ball 108. A slightly wider cutout 112 allows the cone to be oriented coaxially to the piston 208.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A braking device for a PTO transmission unit, comprising:
a bearing plate having one or more recesses;
a ball arranged in each recess; and
a cone having one or more cutouts in the circumferential direction on a side facing the bearing plate, the balls being arranged in the cutouts.

2. The braking device of claim 1, wherein the cone and the bearing plate are arranged coaxially to each other.

3. The braking device of claim 2, wherein the cone is rotatable in a first angular range with respect to the bearing plate.

4. The braking device of claim 3, wherein each cutout extends in the circumferential direction in a second angular range.

5. The braking device of claim 1, wherein each ball is arranged in the associated cutout and is movable in the cutout along the circumferential direction.

6. The braking device of claim 4, wherein a depth of each cutout decreases outside the first angular range but within the second angular range, and a width of each cutout decreases outside the first angular range but within the second angular range.

7. The braking device of claim 1, wherein the cone and the bearing plate are annular.

8. A PTO transmission unit for a work machine including a braking device, comprising:
a bearing plate having one or more recesses;
a ball arranged in each recess; and
a cone having one or more cutouts in the circumferential direction on a side facing the bearing plate, the balls being arranged in the cutouts.

9. The PTO transmission unit of claim 8, further comprising:
an output shaft and a transmission housing, the bearing plate connected to the transmission housing, and the cone rotatably arranged in the transmission housing and mounted on the bearing plate; and
a hub, a piston, a spring element, and a clutch pack, the hub and the piston are connected to the output shaft, the spring element arranged between the piston and the hub, the piston configured to exert a force on the clutch pack and engage the clutch pack when the piston is in a first position, and the braking device is configured to brake a movement or rotation of the piston when the piston is in a second position.

10. The PTO transmission unit of claim 9, further comprising:
a counter plate, and a chamber formed between the counter plate and the piston such that the chamber can be selectively pressurized.

11. The PTO transmission unit of claim 9, wherein the spring element preloads the piston, the spring element is arranged on the hub, and the piston is movable with the spring element in the direction of the cone such that the piston and the cone are connected with a force fit.

12. The PTO transmission unit of claim 9, wherein the bearing plate is designed as part of the transmission housing.

13. The PTO transmission unit of claim 9, wherein the bearing plate and the cone are arranged coaxially to the output shaft.

14. The PTO transmission unit of claim 9, wherein the clutch pack is in the form of a multi-disc clutch arrangement.

15. A work machine including a PTO transmission unit having a braking device, comprising:
a bearing plate having one or more recesses;
a ball arranged in each recess;
a cone having one or more cutouts in the circumferential direction on a side facing the bearing plate, the balls being arranged in the cutouts;
an output shaft and a transmission housing, the bearing plate connected to the transmission housing, and the cone rotatably arranged in the transmission housing and mounted on the bearing plate; and
a hub, a piston, a spring element, and a clutch pack, the hub and the piston are connected to the output shaft, the spring element arranged between the piston and the hub, the piston configured to exert a force on the clutch pack and engage the clutch pack when the piston is in a first position, and the braking device is configured to brake a movement or rotation of the piston when the piston is in a second position.

16. The work vehicle of claim 15, further comprising:
a counter plate, and a chamber formed between the counter plate and the piston such that the chamber can be selectively pressurized.

17. The work vehicle of claim 15, wherein the spring element preloads the piston, the spring element is arranged on the hub, and the piston is movable with the spring element in the direction of the cone such that the piston and the cone are connected with a force fit.

18. The work vehicle of claim 15, wherein the bearing plate is designed as part of the transmission housing.

19. The work vehicle of claim 15, wherein the bearing plate and the cone are arranged coaxially to the output shaft.

20. The work vehicle of claim 15, wherein the clutch pack is in the form of a multi-disc clutch arrangement.
